(19) United States
(12) Patent Application Publication
(10) Pub. No.: US 2025/0248329 A1
(43) Pub. Date: Aug. 7, 2025

(54) Agricultural Mower

(71) Applicant: PÖTTINGER Landtechnik GmbH, Grieskirchen (AT)

(72) Inventors: August Greifeneder, Grieskirchen (AT); Markus REININGER, Grieskirchen (AT); Andreas DIETACHMAIR, Grieskirchen (AT); Norbert ANGLEITNER, Grieskirchen (AT)

(21) Appl. No.: 19/047,225

(22) Filed: Feb. 6, 2025

(30) Foreign Application Priority Data
Feb. 6, 2024 (DE) 10 2024 103 251.0

(51) Int. Cl. A01D 34/66; A01D 34/76

(52) U.S. Cl. CPC A01D 34/664; A01D 34/667; A01D 34/76

(57) ABSTRACT

An agricultural mower including a disc mowing unit suspended on a machine frame, the disc mowing unit having a cutter bar which, in a working position, extends transversely to a direction of travel in a horizontal position. The mowing discs are equipped with blades and are mounted on the cutter bar for rotation about upright axes of rotation. The mowing bar has on at least one end an outer bar end portion which is bent forward and/or curved forward with respect to the direction of travel and on which at least one mowing disc is mounted, which is arranged offset forwards with respect to the mowing discs on a middle portion of the cutter bar in the direction of travel and is provided with an upright conveying drum for conveying clippings towards the center of the cutter bar.

### CROSS-REFERENCE TO RELATED APPLICATIONS

This application claims benefit under 35 USC § 119 of DE Application No. 10 2024 103251.0 filed 6 Feb. 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to an agricultural mower for attaching to a tractor, comprising a disc mowing unit suspended on a machine frame, the disc mowing unit having a cutter bar which, in the working position, extends transversely to the direction of travel in a horizontal position, and the disc mowing unit having mowing discs which are equipped with blades and which are mounted on the cutter bar for rotation about upright axes of rotation, the mowing discs being lined up next to one another, wherein a drive train for rotationally driving the mowing discs comprises drive wheels disposed on the cutter bar, preferably in the form of cylindrical gears in rolling engagement with one another.

### 2. Description of Related Art

Such disc mowing units, in the region of the cutter bar, in terms of height, are usually of a low profile, as the drive of the mowing discs in contrast to drum mowers is provided by a drive train located underneath and guided along the cutter bar. In particular, the drive train located underneath and guided along the cutter bar can have a chain of cylindrical gears that are in rolling engagement with one another, so that the drive movement along the cutter bar takes place from mowing disc to mowing disc, resulting in a lower-lying flow of force or torque along the cutter bar. Thanks to the low profile, the cut material simply glides over the cutter bar, which reduces the driving resistance and also simplifies cooperation with downstream conditioners.

At the same time, this also results in a lightweight design that allows a large working width.

Such a disc mowing unit is illustrated for example in the EP 19 32 414 B1, in which for road transportation the width of the cutter bar can be reduced by folding the outermost mowing discs upwards around horizontal pivot axes parallel to the direction of travel.

In case of disc mowing units having large working widths, for example, of more than 3 m, there often arises a problem of the swath being deposited too wide while being formed from the mowing unit. This can result in part of the swath being rolled over by the front and rear tires of the tractor, e.g., on a front-mounted mowing unit. Even with rear-mounted mowing units, the mower swath formed can be too wide, for example to reliably transfer the mowed crop to an existing slave unit such as a conditioner or transverse conveyor, which, in particular, can be a problem on sloping terrain.

In order to reduce the width of the swath cut by the cutter bar or to direct the portions cut at the edges more towards the center, there are sometimes used the so-called swath discs, which are arranged at the rear behind the cutter bar and can drive themselves through ground contact, wherein the axis of rotation of such swath discs is usually aligned horizontally, inclined at an acute angle to the direction of travel. In order to achieve a greater centering effect or to taper the swath more strongly, such swath discs can be provided in a double arrangement, i.e., two swath discs arranged offset one behind the other on the right and left of each mower side. However, such a double arrangement can cause problems with the fodder flow at the rear swath disc and thus blockages, especially when mowing in layer lines along sloping hill sides or when mowing uphill and downhill.

To avoid such problems with swath discs, other measures for swath formation have already been proposed, for example in the form of driven swath formers or transverse conveyor augers, which can be arranged at the outer edge portions of the mowing drum at the rear. However, such transverse conveyor augers significantly increase the weight and the overall length of the mower, which also applies to roller or tine conditioners that are equipped with transverse conveyor belts or swath guide plates and can be arranged at the rear of the mowing drum.

In order to achieve a transverse conveying effect on the clippings already on the mowing drum itself, so that at best downstream transverse conveying means such as the swath discs or transverse conveyor augers can be dispensed with, it has already been proposed to place tower-like conveyor drums on the two outermost mowing discs, which rotate with the mowing discs and do not simply allow the stalks and leaves cut at the front edge of the mowing drum to run over the mowing drum, but towards the inside, i.e., onto the mowing drum. i.e., towards the center of the cutter bar. The crop cut at the front edge of the cutter bar, which in itself wants to flow straight backwards in relation to the direction of travel, hits the respective conveying drum, whereby the rotation of the conveying drum ensures that the crop does not flow past the conveying drum evenly to the right and left, but is driven to one side. The two outermost mowing discs fitted with the conveyor drums are not driven in opposite directions to each other, as is usual for the inner mowing discs or the mowing discs not fitted with conveyor drums, but are driven in the same direction so that the frontside conveyor drum portions run inwards towards the center of the mowing drum and drive the crop inwards.

Although such conveying drums on the outermost mowing discs of a mowing drum can avoid the space and weight problems of the downstream tools for swath formation, such as transverse conveyor augers, transverse conveyor belts or swath discs, they are particularly sensitive in terms of a reliable transverse conveying effect in difficult mowing conditions, as the cut fodder must be transported from the outermost conveying drum transversely to the direction of travel by means of the second outermost conveying drum towards the center in order to actually taper the deposited swath. Particularly when mowing along layer lines on sloping terrain, the conveying drums positioned downhill tend to no longer convey the clippings sufficiently uphill, whereby in particular the transfer of the clippings from the outermost conveying drum to the second outermost conveying drum at the downhill end of the mowing drum does not work properly and the clippings at least partially pass between the two conveying drums. Similar problems also occur when mowing downhill, as the clippings tend to fall downhill or do not hit the downhill-facing front side of the conveying drum with sufficient force, causing the transverse conveying effect on the front side of the conveying drum to be too weak to reliably force the clippings inwards or towards the center of the mowing drum.

Therefore, the object of the present invention is to create an improved agricultural mower of type mentioned, which avoids the disadvantages of the prior art and advantageously improves the latter. In particular, even in difficult mowing conditions on inclined slopes with downward or inclined travel, a swath which is narrower than the working width of the mower is to be reliably achieved without disturbing the flow of clippings and a compact, narrow and lightweight construction of possible downstream slave units such as conditioners and transverse conveyors is to be made possible.

### BRIEF SUMMARY OF THE INVENTION

According to the invention, the task is solved by an agricultural mower for attaching to a tractor, comprising a disc mowing unit suspended on a machine frame, the disc mowing unit having a cutter bar which, in the working position, extends transversely to the direction of travel F in a horizontal position, and the disc mowing unit having mowing discs which are equipped with blades and which are mounted on the cutter bar for rotation about upright axes of rotation, the mowing discs being lined up next to one another, wherein a drive train for rotationally driving the mowing discs comprises drive wheels disposed on the cutter bar preferably in the form of cylindrical gears in rolling engagement with one another, characterized in that, on at least one end, the cutter bar comprises an outer bar end portion being bent forward and/or curved forward with respect to the direction of travel F, on which at least one mowing disc is mounted, the mowing disc being arranged offset forwards in the direction of travel with respect to the mowing discs on a middle portion of the cutter bar and being provided with an upright conveying drum for conveying clippings towards the center of the cutter bar.

It is therefore proposed to provide the outermost mowing disc of the mowing drum with a conveying drum and to move it forward in order to make it easier for the conveying drum arranged on the outermost mowing disc to convey the clippings inwards towards the center of the mowing drum or to give the clippings to be conveyed inwards more time to reach the inside before the clippings have to merge with the clippings cut further inside to form a swath. According to the invention, the mowing drum comprises on at least one end an outer bar end portion being bent forward and/or curved forward with respect to the direction of travel, on which at least one mowing disc is mounted, the mowing disc being arranged offset forwards with respect to the mowing discs on a middle portion of the mowing drum and being provided with an upright conveying drum for conveying clippings towards the center of the mowing drum. The conveying drum can be positioned coaxially to the upright axis of rotation of the mowing disc and rotate in the same direction as the mowing disc in such a way that a front portion of the rotating conveying drum, in relation to the intended direction of travel, moves transversely to the direction of travel inwards towards the center of the cutter bar. Due to the forward bending end portion of the cutter bar and the forward offset position of the outermost mowing disc of the cutter bar and the conveying drum arranged above it, the crop is cut earlier or further forward at the outer mowing disc end than at a mowing disc portion located further inwards, so that the clippings can be driven inwards more easily by the conveying drum of the outermost mowing disc and can be combined more effectively with the clippings cut further inwards to form an overall tapered swath.

Preferably, the second outermost mowing disc adjacent to the outermost mowing disc is also provided with an upright conveying drum, which is similarly positioned coaxially to the upright axis of rotation of “its” second outermost mowing disc and can thus rotate in the same direction. Preferably, these two adjacent, outermost mowing discs of the mowing bar and corresponding conveyor drums rotate in the same direction, so that the front drum portions of both conveyor drums run inwards towards the center of the mowing bar and accordingly drive the clippings together towards the center of the mowing bar. The synchronization of the directions of rotation of the outer mowing discs of the mowing drum equipped with a conveying drum can therefore deviate from the imbalance of the directions of rotation of the mowing discs on a middle portion of the mowing drum. There, that is, on a middle portion of the mowing drum, the mowing discs can be driven alternately in opposite directions of rotation, so that mowing discs adjacent to each other run in opposite directions.

The second outermost mowing disc and the corresponding conveying drum can also be positioned at the forwardly bending and/or forwardly curved bar end portion and can be offset forward with respect to the mowing discs arranged at the middle portion of the mowing drum.

Alternatively, the second outermost mowing disc and the corresponding conveying drum can also be arranged at the same height as the mowing discs of the middle portion of the mowing drum when viewed in the direction of travel. In particular, the second outermost mowing disc and the corresponding conveying drum can be lined up with the mowing discs of the middle portion of the mowing drum along a virtual straight line that extends transversely to the direction of travel, whereby in particular the upright rotation points of the mowing discs can be lined up along this straight line.

Irrespective of a possible forward offset of the second outermost mowing disc with respect to the mowing discs of the middle portion of the cutter bar, the outermost mowing disc and the adjacent second outermost mowing disc and the respective conveying drums are advantageously arranged offset with respect to one another in the direction of travel, the outermost mowing disc together with the corresponding conveying drum being arranged offset forwards in the direction of travel with respect to the second outermost mowing disc together with the conveying drum, in order to facilitate the transfer of the clippings from the outermost mowing drum to the adjacent, more inner mowing drum and to prevent clippings from passing between the two adjacent mowing drums, in particular when driving on slopes or when mowing downhill or in similarly difficult mowing conditions, in which the conveying drums on the mowing discs conventionally have difficulty in reliably conveying the clippings inwards towards the middle of the bar.

However, the second outermost mowing disc together with the corresponding conveying drum does not have to be arranged on the forwardly bending and/or forwardly curved bar end portion, but can also be arranged on the usually straight middle portion of the cutter bar extending transversely to the direction of travel. In particular, the second outermost mowing disc and conveying drum can be positioned in the transition area of the cutter bar between its forwardly bending and/or forwardly curved outer end portion and the adjacent middle portion, which can be straight or have a straight longitudinal axis.

In a further development of the invention, the offset in the direction of travel of the two outermost mowing discs fitted with conveyor drums can be in the region of 25% to 75% or 30% to 60% or 30% to 50% of the distance between the axes of rotation of the two outermost mowing discs or also between the axes of rotation of two adjacent mowing discs on the inner or central cutter bar portion. The center distance of the axes of rotation of the two outermost mowing discs can be essentially the same as the distance of the axes of rotation of adjacent mowing discs on the middle portion of the cutter bar, whereby in a further development of the invention all mowing discs can be equally spaced from one another with respect to their axes of rotation or the center distances of adjacent mowing discs can be at least approximately the same for all mowing discs.

Irrespective of the distance between the axes of rotation or the offset in the direction of travel in relation thereto, the outer bar end portion bending forwards and/or curved forwards can be inclined forwards at an obtuse angle in relation to the middle portion of the cutter bar, whereby the longitudinal axis of the bar end portion bending forwards and the longitudinal axis of the middle portion of the mowing drum can form an angle in the region of approximately 140° to 170° or 145° to 165° or 150° to 160° in relation to one another. If the outer bar end portion is curved, the angle may be defined by a tangent to the curved end portion and the longitudinal axis of the middle portion, or by a virtual line connecting the axes of rotation of the two outermost mowing discs and a virtual line passing through at least some of the axes of rotation of the mowing discs at the middle portion of the cutter bar.

The middle portion of the cutter bar can extend with its longitudinal axis, which can take a straight course, transversely or perpendicularly to the intended direction of travel, with preferably more mowing discs being arranged on the middle portion of the cutter bar than on the forwardly bent and/or forwardly curved bar end portion. For example, at least twice as many mowing discs can be provided on the middle portion of the cutter bar than on the forward bending and/or forward curved bar end portion. In this way there can be achieved a reasonable compromise between a large working width and sufficient rejuvenation of the swath.

In a further development of the invention, the mowing drum can have at each of its right and left ends an end portion which is bent forwards and/or curved forwards, as described, and which can be equipped in the manner described above with one or two or possibly even more than two mowing discs and conveyor drums arranged thereabove, which can each rotate in the same direction as one another, running inwards at their front side. The mowing discs equipped with conveyor drums arranged on the right bar end portion naturally rotate in the opposite direction to the mowing discs equipped with conveyor drums provided on the left bar end portion in order to achieve a conveying effect to the left on the right bar end portion and a conveying effect to the right on the left bar end portion.

Such a cutter bar configuration with two forward bending or forward turning bar end portions can be particularly useful with a front-mounted front mower in order to taper the swath both at the right edge and at the left edge and to deposit it reliably within the track width of the tractor.

However, in case of mower units projecting to the right or left, for example rear-mounted mower units, it can be sensible to design only the end portion of the respective cutter bar projecting outwards in relation to the tractor track, bending forwards and/or curving forwards, and to leave the mowing disc end portion located further inwards towards the tractor track straight and to design the mowing discs there without corresponding conveyor drums.

Slave units following the mowing drum can be assigned in a known manner, for example a conditioner for conditioning the clippings and/or a transverse conveyor for depositing the swath laterally offset to the center axis of the track of the cutter bar. In a further development of the invention, such slave units can have a reduced working width as compared to the cutter bar. In particular, the described forward bending and/or forward curved bar end portion can sweep over a working path that is laterally adjacent to or outside the working path of the slave unit. The working path of the slave unit can overlap or coincide with the working path of the mowing discs of the middle portion of the cutter bar.

If the cutter bar has a forward bending and/or forward curved end portion on the right and left, the working paths of the forward bending and/or forward curved bar end portions can lie next to or outside the working path of the slave unit. The working width of the slave unit can extend essentially across the entire working width of the mowing discs, which are arranged within the mowing discs on the forwardly curved and/or forwardly bending end portions. Narrowing the slave units in this way saves weight, which not only makes it easier to pivot from working position to transport position, but also allows the mower to hover more light-footedly over the ground during operation and/or improves ground tracking on undulating terrain.

In a further development of the invention, a continuous drive train can be provided on the mowing drum, which is arranged lower-lying or at the height of the cutter bar and can drive all the mowing discs arranged on the mowing drum, in particular including the outermost mowing disc, which is offset forwards, on the forwardly bending or forwardly bent bar end portion. Such a continuous drive train can advantageously be integrated into the mowing drum or arranged in an interior of the cutter bar. Irrespective of this, the drive train can advantageously have cylindrical gears rolling off one another, forming a cylindrical gear chain, so to speak, whereby each mowing disc can be connected in a rotationally fixed manner to a cylindrical gear arranged coaxially thereto. Intermediate cylindrical gears may be provided between the cylindrical gears fixed to the mowing discs in order to transfer the drive power from one mowing disc to the next.

For example, the cylindrical gears mentioned can be cylindrical gears that mesh with one another.

The lower-lying drive train extending along the cutter bar can be connected from above, in particular from a machine frame arranged above the cutter bar, to a drive source such as the power takeoff shaft of a tractor, whereby in particular a drive shaft can be guided downwards from an angular gear located on the machine frame to one of the cylindrical gears of the lower-lying drive train on the mowing drum.

In an advantageous further development of the invention, the drive shaft, which comes from an above-lying drive train part, in particular from an angular gear arranged on the machine frame, may not be guided to the outermost mowing disc of the cutter bar, but to a mowing disc arranged further inwards and/or may be offset inwards, i.e., towards the center of the mowing disc, with respect to the upright axis of rotation of the outermost mowing disc.

In particular, the upright drive shaft can be guided from above to the second outermost mowing disc of the cutter bar, which can be positioned, for example, in the transition area between the forwardly bending bar end portion and the middle portion of the cutter bar adjacent thereto. In this respect, the drive shaft can be connected in a rotationally fixed manner directly to the cylindrical gear to which the second outermost mowing disc is connected in a rotationally fixed manner, or alternatively to one of the intermediate cylindrical gears between the outermost and second outermost mowing discs or the second and third outermost mowing discs.

The connection of the downwardly extending drive shaft to the, for example, second outermost or possibly third outermost mowing disc of the mowing bar is particularly advantageous if the mowing drum is suspended so that it can be folded from a horizontal working position into an upright transport position. This results in fewer restrictions with regard to the length of the power takeoff shafts and power takeoff shaft angles when the cutter bar and the machine frame part supporting it are pivoted between the working and transport positions. In particular, complex angular gear designs, to which the drive shaft going to the cutter bar is connected, or multiple telescopic cardan shafts can be avoided without suffering disadvantages in terms of transport height despite large working widths. The connection of the downward-running drive shaft to the second outermost or third outermost mowing disc of the cutter bar, for example, makes it possible in particular to make the cardan shaft leading to the angular gear on the folding machine frame longer, which extends its telescopic length even with only a few telescopic pieces and/or reduces the articulation angle.

Advantageously, the machine frame or the machine frame part, which can extend above the cutter bar when viewed in the working position and on which the cutter bar is suspended, can be designed to be shorter, in particular shorter than the mowing drum suspended thereon and, for example, only extend above the middle portion of the cutter bar when viewed in the working position, for example only over the length from the second outermost mowing disc on the right to the second outermost mowing disc on the left. In particular, the length of the machine frame on which the cutter bar is suspended can be shortened by the length of the forward bending bar end portion or the sum of the lengths of the two forward bending bar end portions compared to the cutter bar length, so that the mowing drum with its forward bending bar end portion or both forward bending bar end portions projects beyond the machine frame on the right or left or on both sides.

A machine frame shortened in this way can save weight, which facilitates pivoting between the working position and transport position and enables further weight savings thanks to smaller slewing drives.

In a further development of the invention, the forwardly bending and/or forwardly curved bar end portion can be supplemented by an additional mowing drum located further to the outside, which, in a further development of the invention, can be suspended pivotable between different positions with respect to the mowing drum. In particular, such an additional, adjustable mowing drum can be suspended upright about an upright pivot axis with respect to the forwardly bent and/or forwardly curved bar end portion when viewed from the horizontal working position of the mower, in order to be pivoted further forwards or further backwards with respect to the forwardly bent and/or curved bar end portion.

In an advantageous further development of the invention, the upright pivot axis can extend at least approximately coaxially to the axis of rotation of the previously explained outermost mowing disc of the cutter bar, which is uprightly arranged on the forwardly bending and/or forwardly curved bar end portion, so that the additional adjustable mowing drum can be brought into different positions without changing the distance to the outermost mowing disc of the cutter bar, adjustable mowing drum can be adjusted without changing the distance to the outermost mowing disc of the cutter bar with respect to the forwardly bending end portion of the cutter bar or can be brought into various positions in which the additional mowing drum can be positioned further or less far relative to the outermost mowing disc on the forwardly bending bar end portion, as viewed in the direction of travel.

The adjustment range of the additional, adjustable mowing drum can sweep over a virtual line that passes through the axes of rotation of the two outermost mowing discs of the cutter bar and defines the acute angle of the bending end portion of the bar to the longitudinal axis of the middle portion of the mowing drum in the manner described above. For example, the adjustment range of the additional, adjustable mowing drum can be at least +/10° and/or +/25° to the virtual line.

The additional, adjustable mowing drum can be provided at each end portion of the cutter bar, in particular if the mowing drum has the described forwardly bent and/or forwardly curved bar end portion at both ends.

The additional, adjustable mowing drum is preferably driven from above by means of an above-lying drive train, rather than by a lower-lying drive train arranged at the height of the cutting blades. Nevertheless, the drive of the additional, adjustable mowing drum can be coupled to the drive train for driving the mowing discs of the cutter bar.

In a further development of the invention, a mixture of lower-lying and upper lying drive trains can be provided in order to avoid collision-prone gear arrangements and drive train wings with joints in the region of the interface between the additional, pivotable outer mowing drum and the fixed mowing discs of the cutter bar, which impede the fodder flow. For the cutter discs of the cutter bar, the drive train is guided along the bottom of the mowing drum in a manner known per se as described, but then guided upwards in the region of the interface to the pivotable outer mowing drum in order to bridge the interface at the top, and then guided downwards again at the outer mowing disc in order to drive the latter. In particular, the drive train can have an above-lying train portion which extends between the axis of rotation of a mowing disc of the mowing bar and the axis of rotation of the outer, pivotable mowing drum and is drivably connected by upright connecting shafts, on the one hand, to the outer, pivotable mowing drum and, on the other hand, to a lower train portion for driving the mowing discs of the mowing bar.

Together with the two connecting shafts mentioned, the upper train portion forms a U-shaped drive train bridge or a bridge portion standing on the two connecting shafts as bridge pillars, so to speak, in order to connect the lower train portion for the mowing discs of the rigid mowing drum with the outer, pivotable mowing drum. This makes it possible to avoid intermediate gears known from the prior art, such as those located behind the cutter bar in the direction of travel, and articulated or pivoting drive train arms at the height of the cutter discs. This means that the fodder flow can also pass unhindered over the intermediate swivel interface in the region of the interface between the swivel-mounted outer mowing drum and the adjacent, inner mowing disc and, in particular, that slave units arranged behind the mowing disc, such as a conditioner, can be reliably operated if such a slave unit is required for fodder processing.

In a further development of the invention, the two aforementioned upright connecting shafts between the upper drive train portion and the lower-lying drive train portion or the outer mowing disc can be arranged at least approximately coaxially to the axis of rotation of the outer, pivotable mowing drum on the one hand and to the axis of rotation of one of the mowing discs of the mowing disc on the other hand.

The connecting shafts can advantageously take the form of cardan shafts, for example in the form of double cardan shafts, in order to be able to compensate for axle misalignment, for example due to torsion between the upper drive train portion and the lower-lying mowing discs.

In particular, the connecting shaft, which connects the upper train portion with the lower train portion for driving the inner mowing discs, can be arranged approximately coaxially to the pivot axis about which the outer mowing drum can be pivoted relative to the rigid mowing drum. As a result, the articulation of the suspension of the outer mowing drum coincides at least approximately with the connecting shaft, whereby the upper drive train portion, which extends between the upright pivot axis and the axis of rotation of the outer mowing member, is simply formed; in particular, no articulations need to be provided or kinematic subsequent movements compensated due to the pivotability.

The upper drive train portion, which forms the connecting leg, so to speak, of the drive train between the two upright connecting shafts, can in particular have a horizontal extension or orientation and preferably extend in a horizontal position from the axis of rotation of the outer mowing disc to the axis of rotation of one of the mowing discs located further inwards. Irrespective thereof, the upper drive train portion can extend approximately at the height level of the machine frame on which the mowing drum is suspended, whereby the upper drive train portion can in particular be arranged directly below the machine frame.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a perspective front view of an agricultural mower having a cutter bar with right and left bar end portions each bending forward in the direction of travel, the two outermost mowing discs of the cutter bar being provided with upright conveyor drums for conveying the clippings inwards towards the center of the bar.

FIG. 2 is a plan view of the mower from FIG. 1, showing the forward bending bar end portions and the reduced working width of a slave unit in the form of a conditioner compared to the mowing drum.

FIG. 3 is a perspective front view of the cutter bar of the mower from the foregoing figures, showing the forwardly bending end portions of the cutter bar and the fitting of the conveyor drums to the two outermost mowing discs arranged on the right and left.

FIG. 4 is a plan view of the cutter bar and its mowing discs from FIG. 3.

FIG. 5 is a perspective front view of a cutter drum and its suspension on a machine frame of a mower similar to the foregoing figures, wherein two swath discs are provided as a subsequent slave unit to further taper the width of the swath.

FIG. 6 is a plan view of the mowing drum and the trailing swath discs from FIG. 5.

FIG. 7 is a perspective front view of the cutter bar from the foregoing figures, showing the connection of the drive train to a second outermost mowing disc via a drive shaft coming from above and connected to an angular gear on the machine frame.

FIG. 8 is a plan view of the cutter bar and its drive train from FIG. 7.

FIG. 9 is a perspective front view of the cutter bar similar to FIG. 8, which shows the connection of the lower-lying drive train of the cutter bar to an upper angular gear via a drive shaft coming from above, whereby, as an alternative to FIGS. 7 and 8, the drive shaft is not guided coaxially to the second outermost mowing disc to the mowing drum, but is connected to an intermediate cylindrical gear between the two outermost mowing discs.

FIG. 10 is a plan view of the mowing drum in FIG. 9 and its connection to the drive train via an intermediate cylindrical gear.

FIG. 11 is a perspective view of the cutter bar and the machine frame on which the mowing drum is suspended, whereby similarly but alternatively to FIG. 7 the drive train to the angular gear on the machine frame takes place from one end face of the machine frame and shows the elongated configuration of the cardan shaft, which is made possible by the connection of the drive train to the second outermost mowing disc.

FIG. 12 is a plan view of the mowing drum and its suspension on the machine frame from FIG. 11, showing the cardan shaft leading to the front of the shortened machine frame.

FIG. 13 is a perspective view of a cutter bar with forwardly bending bar end portions and the suspension of the cutter bar on a machine frame, wherein, in addition to the previous embodiments, an additional, adjustable mowing drum is provided laterally next to the outermost mowing disc of the cutter bar, which drum is adjustable about an upright pivot axis relative to the forwardly bending bar end portion.

FIG. 14 is a plan view of the mowing drum and its suspension on the machine frame from FIG. 13, showing the adjustability of the additional mowing drum.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

As shown in the figures, the mower 1 comprises a machine frame 2 which can have a longitudinal beam 23 which, in the working position, can extend transversely to the direction of travel above a disc moving unit 3. The machine frame 2 can be attached to the rear or, in particular, the front of a tractor using a mounting device known as such, whereby the mounting device can, for example, have a headstock that can be attached to the tractor using a three-point linkage with an upper link and two lower links.

The disc mowing mechanism 3 can form a front mower driven centrally in front of the tractor, but alternatively it can also form a side wing of a mower combination which can be moved into a transport position, for example about a horizontal or vertical pivot axis, whereby in this case the mower can be suspended, for example with the longitudinal beam 23, on a central machine frame part which is attached to the tractor.

As shown in the FIGS., the disc mowing mechanism 3 has a mowing drum 4 which is oriented horizontally transversely to the direction of travel F, at least in the working position of the mower 1, a plurality of mowing discs 5 being mounted on the mowing drum 4 so as to be rotatable about respective upright axes of rotation 7. The mowing discs 5 can be plate-shaped and equipped with blades on their circumference, which cut around the crop in a manner known per se when the mowing discs 5 are rotationally driven along their orbits.

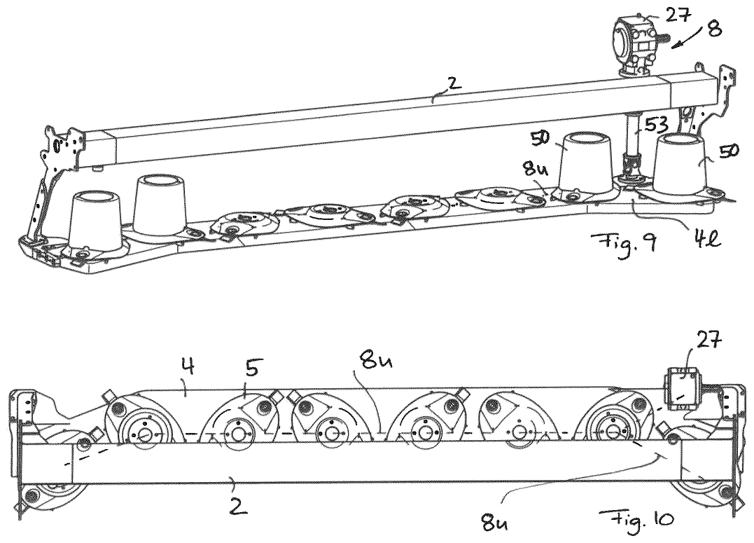

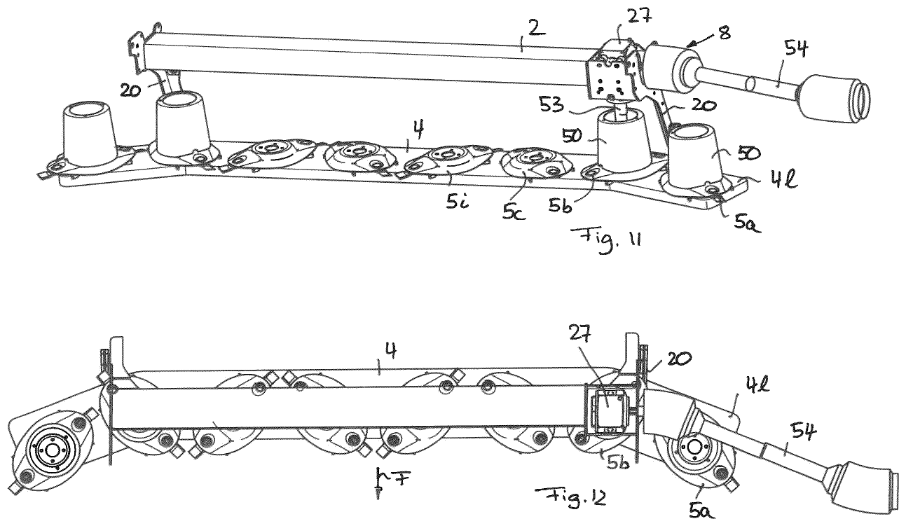

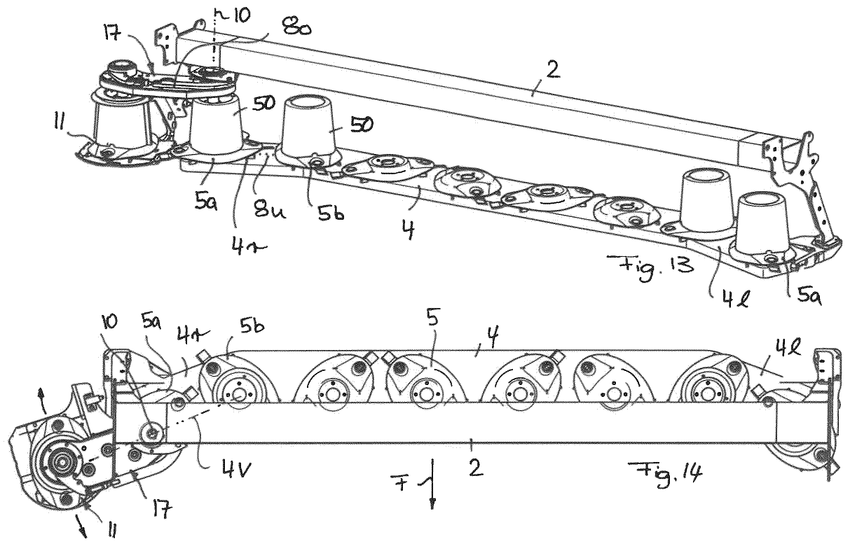

The mowing drum 4 is suspended on the machine frame 2. For this purpose, a retaining stem or mowing drum support 20 can be provided, which on the one hand is rigidly attached to the machine frame 2 and on the other hand can be rigidly connected to the cutter bar 4 and can, for example, extend diagonally upwards from the rear side of the cutter bar 2 to the machine frame 2, cf. FIGS. 5 to 10, whereby the holding handle 20 can be attached to the outer end of the cutter bar, see FIGS. 9 and 13, or offset a little further inwards, for example in the region of a second outermost mowing disc 5b, cf. FIGS. 5, 7 and 11.

Two such retaining stems or mowing drum supports 20 can be provided on the right and left end portions of the cutter bar 4, in particular each offset inwards by one piece, as will be explained.

The inner mowing discs 5i are lined up along the longitudinal axis of the cutter bar 4 in a fixed position along an aligned connecting line 4L, which can extend as a straight line transversely to the direction of travel F.

In addition to the inner mowing discs 5i, at least one outer mowing disc 5a is provided, which is arranged at the outer end of the cutter bar 4 and is offset forwards in the direction of travel relative to the inner mowing discs 5i. In particular, such outer mowing discs 5a can be provided on both, i.e., on the right and left end portions of the cutter bar 4 and arranged offset to the front.

As shown in the FIGS., the mowing drum 4 has on at least one end, preferably both ends, a bar end portion 4L or 4r which bends forwards and/or is curved forwards in the direction of travel F and on which the outermost mowing disc 5a is arranged. The forwardly bent and/or forwardly curved bar end portions 4L or 4r are preferably significantly shorter than the middle portion 4m of the cutter bar 4, with significantly more mowing discs 5 being arranged on the middle portion 4m than on the respective outer bar end portion 4L or 4r. For example, twice as many or three times as many or four times as many mowing discs 5 can be arranged on the middle portion 4m of the cutter bar 4 as on the respective forwardly bent bar end portion 4L or 4r.

The outer bar end portions 4L, 4r can enclose an angle β with their longitudinal axis or a tangent thereto, which can be, for example, in the region of 150°-170° or 150° to 165°, for example about 155° or 160°, cf. for example FIG. 4. The angle β can be defined in particular between a virtual line 4L, which passes through the axes of rotation of the mowing discs 5 of the middle portion 4m of the cutter bar 4, and a virtual line 4V, which passes through the upright axes of rotation of the outermost and second outermost mowing discs 5a, 5b, cf. FIG. 4.

In the direction of travel F, the outermost mowing disc 5a can have an offset V with respect to the second outermost mowing disc 5b, which is measured between the axes of rotation of the outermost and second outermost mowing discs and can be approximately 20%-100% or 25%-75% or 30%-60% of the distance between the axes of rotation of the outermost and second outermost mowing discs, cf. FIG. 4.

The forwardly bent or forwardly curved bar end portions 4L and 4r are advantageously rigidly connected to the middle portion 4m of the mowing drum 4, for example integrally formed, so that the forwardly offset position of the outermost mowing disc 5a is fixed relative to the mowing discs 5 located further inwards.

As the FIGS. show, the two outermost mowing discs 5a and 5b are each provided with a tower-like conveying drum 50 which is upright in the working position of the cutter bar 4, is arranged coaxially with the axes of rotation of “its” mowing discs 5a and 5b and can rotate or revolve synchronously with the mowing discs.

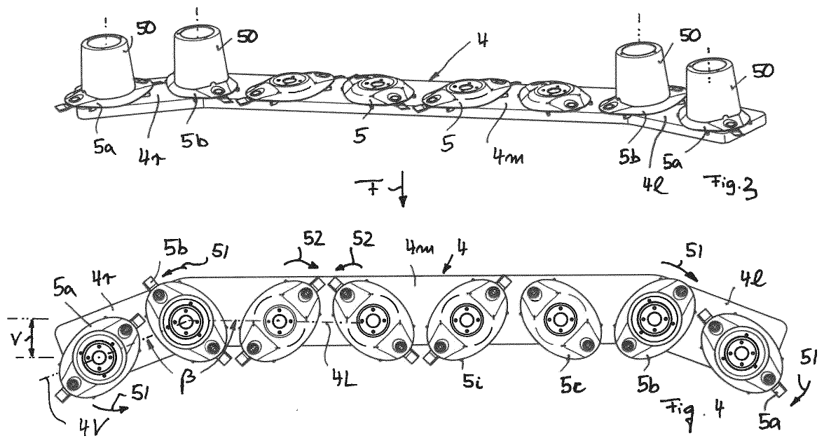

As the arrows 51 illustrate, cf. FIG. 2 or 4 or 6, the two outermost mowing discs 5a and 5b and the conveyor drums 50 arranged above them rotate in the same direction at each end of the cutter bar, namely in a direction of rotation in which the front sectors of the conveyor drums 50 in the direction of travel run inwards towards the center of the cutter bar. As a result, the conveying drums 50 each drive the incoming clippings inwards or towards the center of the cutter bar, wherein the conveying drum 50 of the outermost mowing disc 5a can drive the clippings inwards at least to the extent that they can hit the conveying drum 50 of the second outermost mowing disc 5b or can then be driven further inwards towards the center of the cutter bar by this second outermost conveying drum. The offset of the conveying drum 50 on the two outermost mowing discs 5a and 5b in the direction of travel F makes it easier for the conveying drum 50 on the outermost mowing disc 5a to drive the clippings inwards to such an extent that they do not pass between the two conveying drums, but reach the inside of the conveying drum on the second outermost mowing disc 5b.

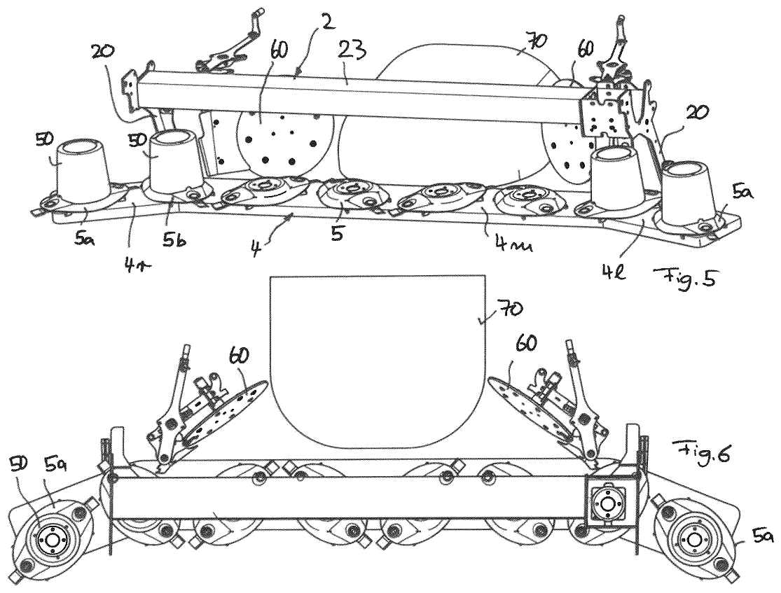

In contrast to the two outermost mowing discs 5a and 5b, the mowing discs 5 arranged on the middle portion 4m of the cutter bar 4 can be driven alternately in one and the other rotational direction of rotation, cf., for example, the direction of rotation arrows 52 in FIG. 4 and FIG. 6.

The mowing discs 5 of the cutter bar 4 can be driven by a lower-lying drive train 8u, which can be integrated into the mowing drum 4 or extend along the cutter bar 4, wherein the drive power is transmitted from mowing disc to mowing disc.

The lower drive train portion 8u can have a cylindrical gear in a manner known per se, which has a series of cylindrical gears which are lined up along the cutter bar 4 and are in rolling engagement with one another, each of the mowing discs 5 being coupled in a rotationally fixed manner to one of the cylindrical gears. The rotary movement of the mowing discs 5i is synchronized with each other via intermediate cylindrical gears and the drive power is transmitted further, with gear wheels preferably meshing with each other.

The drive movement can be transmitted from a power takeoff shaft of the tractor (not shown) via a cardan shaft 54 and introduced into a mowing disc 5 at one or the other end of the mowing drum 4. As the embodiments shown in FIGS. 5 to 8 and 11 to 12 show, an angular gear 27 can be provided, for example, at an end portion of the machine frame 2 in order to initiate the drive movement in the mowing disc 5 below and then transmit it from mowing disc to mowing disc along the mowing drum 4 via the drive train 8, or more precisely the lower drive train portion 8u. However, if necessary, the drive power can also be fed into the drive train 8 at another point.

In particular, the drive movement can be initiated in the lower-lying drive train 8u in the region of the second outermost mowing disc 5b, whereby the angular gear 27 can be arranged above the second outermost mowing disc 5b on the machine frame 2 or possibly also a little way behind it, as shown in FIG. 9 and FIG. 10. The drive movement can be transmitted downwards from the angular gear 27 to the mowing drum 4 via an upright drive shaft, whereby the upright drive shaft can be arranged coaxially to the axis of rotation of the second outermost mowing disc 5b, for example, and can extend through the conveying drum 50. The drive shaft can be connected directly to a cylindrical gear of the lower-lying drive train 8u, which in turn can be connected to the second outermost mowing disc 5b.

However, as FIG. 9 and FIG. 10 show, the upright drive shaft 53 can also be guided downwards outside the conveyor drums 50 and/or be connected in a rotationally fixed manner to an intermediate cylindrical gear, which can be provided between the two outermost mowing discs 5a and 5b, cf. FIG. 9 and FIG. 10, or can also be provided between the second outermost mowing disc 5b and a third outermost mowing disc. In particular, the drive shaft 53 can in this case be arranged above a rear edge or a rear edge area of the cutter bar 4, in particular behind the conveying drum 50 of the outermost mowing disc 5a, so that clippings do not get caught on the drive shaft 53.

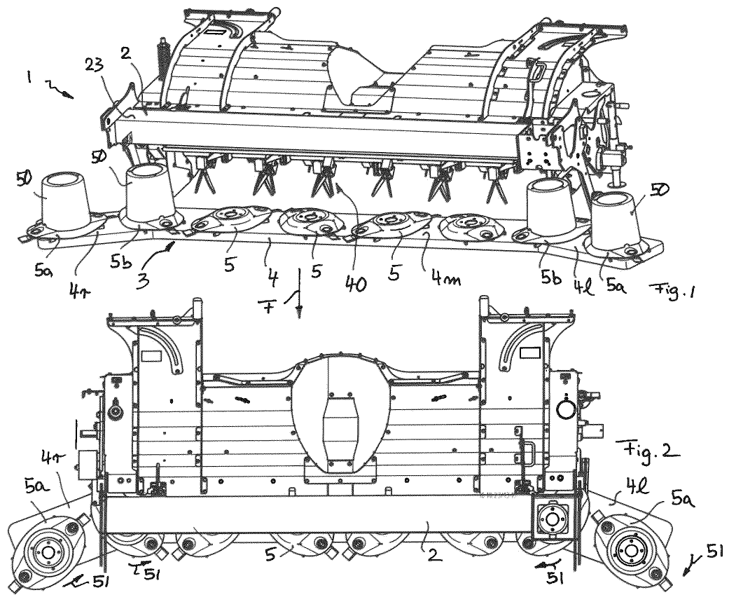

As FIGS. 1 and 2, 5 and 6, 7 and 8 as well as 11 and 12 show, the machine frame 2, in particular its longitudinal beam 23, can advantageously be designed shorter than the cutter bar 4 and/or extend only above the middle portion 4m of the cutter bar 4, so that the forwardly bent bar end portions 4L, 4r project to the right and left over the machine frame 2. This can save weight.

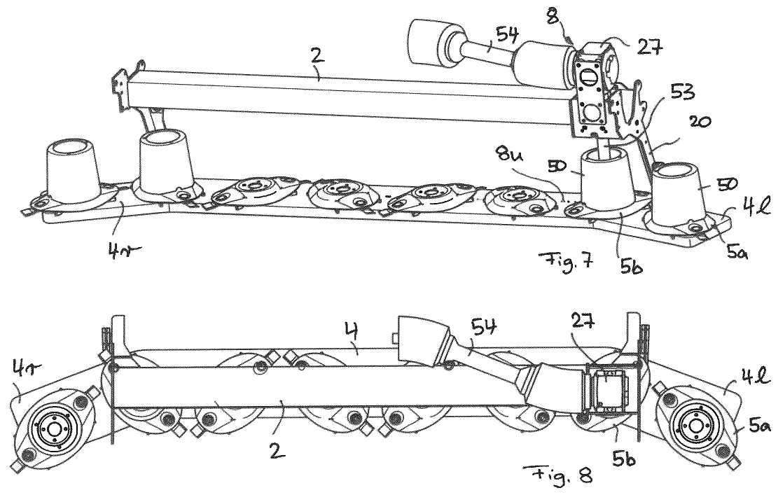

By connecting the drive train 8 to the mowing drum 4 not completely on the outside in the region of the very outer mowing disc 5a, but offset inwards in the region of the second outermost mowing disc 5b or offset even further inwards, the angular gear 27 can also advantageously be positioned offset inwards in a corresponding manner, cf. FIGS. 7 to 12, whereby a cardan shaft 54 continuing from the angular gear 27, which can drive the angular gear 27 for example from a power takeoff shaft of the tractor, can be designed more favorably, in particular can be longer and/or can have joints spaced further apart.

This facilitates in particular the pivoting of the disc mowing mechanism 3 from the lowered working position into an upright transport position, especially if the disc mowing mechanism 3 forms a side wing of the mower and the cardan shaft 54 is guided away from the machine frame 2 at the end face, for example in order to be continued on a central machine frame part. By moving the angular gear 27 inwards, in particular over the second outermost mowing disc 5b, the cardan shaft 54 is given additional length, as it can run over the outermost mowing disc 5a, cf. FIG. 12, which has a favorable effect on the telescopic length of the cardan shaft 54, namely achieves greater telescopability with fewer telescopic parts, and allows smaller articulation angles to be sufficient when pivoting the machine frame 2 into the transport position.

As FIGS. 1 and 2 show, slave units 40 following the disc mowing mechanism 3 can be provided, for example in the form of a conditioner, which can have a conditioner rotor with rotating conditioner tools and can, for example, rotate in the working position about a horizontal axis of rotation transversely to the direction of travel F, cf. FIG. 1 and FIG. 2. Alternatively or in addition to such a conditioner, a transverse conveyor auger or a transverse conveyor belt can also be provided as a slave unit 40, for example, in order to move the clippings or the swath transversely to the direction of travel F and deposit them at the side. For example, such a transverse conveyor can be provided for rear-mounted mower wings in order to be able to fold the swath cut by the side wings towards the center.

As shown in FIGS. 1 and 2, such a slave unit 40 can advantageously have a smaller working width than the mowing drum 4. In particular, the described forwardly bent and/or forwardly curved bar end portions 4L, 4r can sweep over working paths that are laterally adjacent to or outside the working path of the slave unit 40. In particular, the slave unit 40 can have a working width that corresponds approximately to the working width of the middle portion 4m of the mowing drum 4 or corresponds to the width of the swath, which is reduced compared to the entire working width of the cutter bar 4.

By shortening or narrowing the slave units 40 in this way, a further weight saving can be achieved, which not only makes it easier to lift the mower 1 into a transport position, but above all also enables it to float more easily over bumps or other uneven terrain and thus improve ground adaptation.

As FIGS. 5 and 6 show, swath discs 60 can also be arranged behind the cutter bar 4 in the direction of travel F in order to further narrow the swath 70 or shift it even further towards the center of the bar. The swath discs 60 can be mounted to rotate about horizontal disc axles inclined at an acute angle to the direction of travel F and drive themselves rotationally through contact with the ground.

In order to cooperate effectively with the conveyor drums 50, the swath discs 60 can be positioned behind the conveyor drums 50 of the second outermost mowing discs 5b and transversely to the direction of travel on the inside of the working path of the conveyor drums 50, cf. FIG. 6, so that the swath discs 60 can catch the clippings and guide them further inwards, which flow from the conveyor drums 50 of the second outermost mowing discs 5b from their inside over the mowing drum 4. The swath discs can each sweep over a working path that connects on the inside to the working path of the inner conveyor drums 50, cf. FIG. 6.

If necessary, upright guide plates can be provided in the region of a gap between the swath discs 60 and the conveyor drums 50 in order to guide the clippings coming from the conveyor drums 50 essentially completely onto the swath discs 60, cf. FIGS. 5 and 6.

As shown in FIGS. 13 and 14, in addition to the mowing discs 5 provided on the mowing bar 4, an additional mowing drum 11, which is located further out, can be provided, which is pivotably suspended between different positions relative to the mowing drum 4, namely about a pivot axis 10 which is upright in the working position and which can advantageously extend coaxially to the axis of rotation of the outermost mowing disc 5a, cf. FIGS. 13 and 14. This additional, can be pivoted mowing drum 11 is arranged transversely to the direction of travel F next to the outermost mowing disc 5a of the cutter bar 4 and is advantageously offset a little further forward in relation to it in the direction of travel F, whereby the additional mowing drum 11 can be selectively positioned more or less forward relative to the outer mowing disc 5a in the direction of travel by pivoting about the pivot axis 10.

The additional mowing drum 11 can advantageously be suspended pivotably on the machine frame 2 or its longitudinal beam 23 by means of a suspension 17, cf. FIGS. 13 and 14.

The upright pivot axis 10 of the suspension 17 for pivoting the outer mowing drum 5a can preferably coincide with the axis of rotation 7 of one of the mowing discs 5 of the mowing bar 4, in particular with the axis of rotation 7 of the outermost, forwardly offset mowing disc 5a or also of the second outermost mowing disc 5b of the mowing bar 4, which is directly adjacent to the outermost mowing disc 5a.

The pivoting suspension 17 for the outer mowing drum 11 has an above-lying pivot beam which, starting from the pivot axis 10, can extend horizontally to the axis of rotation of the additional mowing drum 11. The pivot beam can be aligned in a horizontal position and/or positioned directly below the machine frame 2 and project from an end portion of the machine frame 2, cf. FIGS. 13 and 14.

The pivot beam can form a hollow profile, for example a plate-shaped box beam, which can be mounted on the machine frame 2 or a rigidly connected bearing bracket by means of a pivot bearing about the upright pivot axis 10.

The pivot beam in turn carries the outer mowing drum 11 with its projecting end portion.

As shown in the FIGS., the outer mowing drum 11 can be pivoted towards the front of the mowing bar 4 or forwards in the direction of travel by the pivoting suspension 17, with FIG. 14 showing an intermediate position which is partially pivoted forwards and still outside the outermost mowing discs of the mowing bar 4, which can be used as a working position, while a working position which is pivoted further forwards again and also a working position which is offset less far forwards can be set. The arrows above and below the mowing drum 11 in FIG. 14 illustrate the pivotability of the additional, adjustable mowing drum 11 further or less far forward with respect to the direction of travel F, whereby the pivoting range of the mowing drum 11 can include the virtual line 4V through the axes of rotation of the outermost and second outermost mowing discs at the forwardly bending bar end portion 4r and can extend beyond it on both sides, cf. FIG. 14.

The pivoting suspension can have an actuator for motorized adjustment of the pivot positions or for setting different pivot positions of the outer mowing drum, for example in the form of an actuating cylinder, which can be designed as a pressure medium cylinder and articulated on the pivot beam of the suspension 17 on the one hand and on the machine frame 2 or its bearing bracket on the other hand, each at a distance from the pivot axis 10, although a hydraulic motor can also be provided for pivoting, for example, or no drive can be provided at all, but manual adjustment can be provided. The actuator can, for example, operate continuously and “freeze” or stop in any position for operation and/or transportation and hold the respective position, or it can also operate in stages or be designed to approach only individual adjustment stages.

The drive movement to the outer pivotable mowing drum is preferably not transmitted lower-lying along the cutter bar 4 further outwards, but is transmitted via a drive train bridge and thus above-lying from the outermost or second outermost mowing disc 5a, 5b to the adjustable mowing drum 11. This drive train bridge can have an above-lying drive train portion 80, which can extend approximately at the level of the machine frame 2 from the axis of rotation 7 of the second outermost mowing disc 5i to the outer mowing disc 5a. This above-lying drive train portion 80 can in particular be integrated into the pivoting beam of the pivoting suspension 17 for the outer mowing disc 5 or extend along this pivoting beam 18.

The upper train portion 8o is guided downwards via two upright connecting shafts. The inner connecting shaft can extend coaxially to the axis of rotation of the outermost mowing disc 5a on the mowing drum 4 and pass through its conveying drum 50, and couple the above-lying drive train 8o to the lower-lying drive train 8u.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. An agricultural mower comprising:
a cutter bar comprising an outer bar end portion on at least one end, the outer bar end portion being bent forward and/or curved forward with respect to a direction of travel; and
mowing discs mounted to the outer bar, at least one of the mowing discs mounted on the outer bar end portion, the mowing disc mounted on outer bar end portion being:
arranged offset forwards in the direction of travel with respect to mowing discs on
a middle portion of the cutter bar; and
provided with an upright conveying drum for conveying clippings towards the center of the cutter bar.

2. An agricultural mower according to claim 1 further comprising:
a disc mowing unit suspended on a machine frame; and
a drive train comprising drive wheels;
wherein:
the agricultural mower is for attaching to a tractor;
the disc mowing unit has the cutter bar which, in a working position, extends transversely to the direction of travel in a horizontal position;
the disc mowing unit having the mowing discs which are equipped with blades and which are mounted on the cutter bar for rotation about upright axes of rotation;
the mowing discs are lined up next to one another;
the drive train is for rotationally driving the mowing discs; and
the drive wheels are disposed on the cutter bar.

3. The agricultural mower according to claim 2, wherein:
at the forwardly bent and/or forwardly curved bar end portion, an outermost mowing disc of the cutter bar and a second outermost mowing disc of the cutter bar adjacent to outermost mowing disc;
the second outermost mowing disc is provided with an upright conveying drum;
the outermost and second outermost mowing discs and the corresponding conveyor drums arranged thereabove are configured to be driven to rotate in the same direction of rotation in which a front drum portion of the corresponding conveyor drums in the direction of travel runs inwards towards the center of the cutter bar.

4. The agricultural mower according to claim 3, wherein the cutter bar comprises two outer bar end portions, one each on opposite ends of the cutter bar.

5. The agricultural mower according to claim 4, wherein:
the two outermost mowing discs at the opposite ends of the cutter bar are each provided with a conveying drum which is upright in the working position;
the two outermost mowing discs and the corresponding conveying drums at a lefthand end of the cutter bar are configured to be driven in the same direction of rotation in such a way that the conveyor drums convey clippings to the right, towards the center of the cutter bar; and
the two outermost mowing discs and the corresponding conveyor drums at a right end of the cutter bar are configured to be driven in the same direction with respect to one another in such a way that the conveyor drums convey clippings to the left towards the center of the cutter bar.

6. The agricultural mower according to claim 2, wherein:
wherein the forwardly bent and/or forwardly curved bar end portion on at least one end of the cutter bar forms an angle β with respect to the middle portion of the cutter bar; and
the angle β is between 140° to 170°.

7. The agricultural mower according to claim 2, wherein:
wherein the forwardly bent and/or forwardly curved bar end portion on at least one end of the cutter bar forms an angle β with respect to the middle portion of the cutter bar;
the angle β is defined by:
a virtual line passing through an axis of rotation of the outermost mowing disc at the forwardly bent and/or forwardly curved bar end portion and an axis of rotation of the second outermost mowing disc; and
a virtual line passing through the axes of rotation of the mowing discs on the middle portion of the cutter bar.

8. The agricultural mower according to claim 6, wherein the outermost mowing disc arranged at the forwardly bent and/or forwardly curved end portion has an offset in the direction of travel with respect to the adjacent, second outermost mowing disc, which offset is between 25% and 75% of a distance between the two axes of rotation of two the outermost and second outermost mowing discs.

9. The agricultural mower according to claim 2, wherein at least one of:
the middle portion of the cutter bar is at least twice as long as the forwardly bent and/or forwardly curved bar end portion;
the middle portion of the cutter bar carries at least twice as many mowing discs as the forwardly bent and/or forwardly curved bar end portion.

10. The agricultural mower according to claim 3, wherein the drive train is guided to the cutter bar from above, as viewed in the working position, and is connected to a lower-lying portion of the drive train extending along the cutter bar in the region of a second outermost or a third outermost mowing disc.

11. The agricultural mower according to the claim 10, wherein the lower-lying drive train extending along the cutter bar is connected to an upright drive shaft extending through the conveying drum of the second outermost mowing disc.

12. The agricultural mower according to claim 10, wherein the lower-lying drive train extending along the cutter bar is connected by means of an intermediate cylindrical gear to an upright drive shaft which, viewed in the direction of travel, extends behind the conveying drum of the outermost mowing disc and, viewed transversely to the direction of travel, extends between the axes of rotation of the outermost and second outermost mowing discs.

13. The agricultural mower according to claim 3 further comprising:
an angular gear;
a cardan shaft; and
a drive shaft;
wherein:
the angular gear is provided in a region of the end portion of the machine frame carrying the cutter bar, which is offset inwards transversely to the direction of travel with respect to the axis of rotation of the outermost mowing disc of the cutter bar;
and
the cardan shaft is connected to the angular gear and is configured to drive the angular gear from the drive shaft.

14. The agricultural mower according to claim 13, wherein, in the working position of the cutter bar, the cardan shaft is guided from the angular gear above the forwardly bent and/or forwardly curved bar end portion.

15. The agricultural mower according to claim 2, wherein:
the machine frame carrying the cutter bar is shorter than the cutter bar; and
the cutter bar with the at least one forwardly bent and/or forwardly curved bar end portion projects beyond the machine frame transversely to the direction of travel.

16. The agricultural mower according to claim 3, wherein:
the machine frame carrying the cutter bar is shorter than the cutter bar;
the cutter bar with the forwardly bent and/or forwardly curved bar end portions projects beyond the machine frame transversely to the direction of travel;
the machine frame extends above the cutter bar only up to the respective second outermost mowing discs; and
the cutter bar is suspended from the machine frame by two retaining stems which are fastened to the cutter bar in a region of the second outermost mowing discs.

17. The agricultural mower according to claim 2 further comprising a slave unit;
wherein:
the slave unit is provided downstream of the cutter bar;
the slave unit has a smaller working width than the cutter bar; and
the at least one forwardly bending and/or forwardly curved bar end portion of the cutter bar sweeps over a working path which lies laterally adjacent to and outside a working path of the slave unit.

18. The agricultural mower according to claim 3 further comprising a mowing drum;
wherein the mowing drum is:
pivotable with respect to the cutter bar about an upright pivot axis in the working position;
arranged transversely to the direction of travel next to the outermost mowing disc of the cutter bar; and
selectively positionable forwardly offset with respect to the outermost mowing disc in the direction of travel by pivoting about a pivot axis.

19. The agricultural mower according to claim 18, wherein the drive train has an above-lying train portion which extends between the axis of rotation of the mowing disc of the cutter bar and the axis of rotation of the pivotable mowing drum and is drivably connected by upright connecting shafts on the pivotable mowing drum and to a lower train portion of the drive train for driving the mowing discs of the cutter bar.

20. The agricultural mower according to claim 19, wherein:
a first connecting shaft of the connecting shafts is arranged at least approximately coaxially to the axis of rotation of the mowing drum and a second connecting shaft of the shafts is arranged at least approximately coaxially to the axis of rotation of the outermost mowing disc on the forwardly bending and/or forwardly curved bar end portion of the cutter bar; and
the second connecting shaft is arranged at least approximately coaxially to the pivot axis about which the mowing drum is pivotable and extends through the corresponding conveying drum of the outermost mowing disc.
